(19) United States
(12) Patent Application Publication
(10) Pub. No.: US 2007/0125876 A1
(43) Pub. Date: Jun. 7, 2007

(54) Nozzle system for the treatment of web-shaped material

(76) Inventors: Ralf Bolling, Aachen (DE); Krysztof Hornig, Aachen (DE); Klaus Schmitz, Simmerath (DE); Winfried Sommereisen, Aachen (DE)

Correspondence Address: PROSKAUER ROSE LLP;PATENT DEPARTMENT, 1585 BROADWAY, NEW YORK, NY, 10036-8299, US

(21) Appl. No.: 11/482,281

(22) Filed: Jul. 6, 2006

(30) Foreign Application Priority Data
Jul. 28, 2005 (DE) 10 2005 035 984.1
Nov. 18, 2005 (DE) 10 2005 054 995.0

(51) Int. Cl. B05B 1/00; F26B 13/00

(52) U.S. Cl. 239/270; 34/640; 239/589

(57) ABSTRACT

The invention relates to a nozzle system for the treatment of web-shaped material, especially metal strip, comprising nozzle surfaces (1, 1*, 1**) each having a plurality of nozzle apertures (1a), disposed at least on one side of the web-shaped material and located successively in the direction of transport of the web-shaped material. The nozzle system is characterised in that the nozzle surfaces (1, 1*, 1**) are bordered in groups by slit-shaped nozzles (3, 3*, 3**) running transverse to the direction of transport of the material.

### BACKGROUND

The invention relates to a nozzle system for the treatment of web-shaped material, especially metal strip, comprising nozzle surfaces each having a plurality of nozzle apertures, disposed at least on one side of the web-shaped material and located successively in the direction of transport of the web-shaped material.

Nozzle systems of this type are known from the prior art in numerous designs. They are used for example in levitation strip furnaces in which metal strips are heat-treated free from contact, e.g. are stress-relief annealed. Other applications are in textile technology where material webs are guided in a levitation manner after printing or in painting technology for drying purposes after painting installations. Usually in said applications, the web-shaped material is guided horizontally and is guided in a levitation manner by a treatment gas stream flowing out from nozzle surfaces disposed above and below the web. The gas flow impinging upon the surface of the web-shaped material then flows back through return flow channels formed between the nozzle surfaces which are spaced apart from one another. Instead of a gas, a liquid can also be used as the treatment medium for certain applications.

### SUMMARY OF INVENTION

A levitation nozzle array is described in EP 0 864 518 B1 which is used for non-contact heat treatment and drying of material webs by means of treatment gas. This comprises a number of successive nozzle surfaces with round nozzle holes disposed above and below the material web. At their two edges each running transverse to the direction of transport of the material web, the nozzle surfaces each have slit-shaped nozzles. As a result of this nozzle geometry, a longitudinal and transverse flow is obtained directly on the surface of the material web when seen in the direction of transport. At the same time, the transverse flow towards the edge of the material web increases so that undesirable increased heat transfer occurs there, resulting in a non-uniform treatment result when seen over the width of the material web, and in a diminishing carrying force.

It is thus the object of the invention to provide a nozzle system of the type specified initially which makes it possible to achieve a particularly uniform treatment result in the heat treatment or drying of a web-shaped material.

The object is achieved according to the invention in a nozzle system according to the preamble of claim 1 by the nozzle surfaces being bordered in groups by slit-shaped nozzles running transverse to the direction of transport of the material.

In the nozzle system according to the invention, each nozzle surface no longer has slit-shaped nozzles on both sides running transverse to the direction of transport of the web-shaped material, as is known from the prior art, but the nozzle surfaces are preferably combined in groups of preferably two but also more nozzle surfaces where only the nozzle surfaces located at the edge are each bordered by a slit-shaped nozzle on their outer edges running transverse to the direction of transport of the web-shaped material. In the case of nozzle surfaces bordered in pairs by slit-shaped nozzles, each nozzle surface is the thus allocated a slit-shaped nozzle, the slit-shaped nozzles of respectively adjacent groups or pairs being arranged directly adjacent to one another. As a result of the grouping of the nozzle surfaces provided according to the invention by means of the slit-shaped nozzles bordering the nozzle surfaces, a substantially two-dimensional flow, i.e. a flow perpendicular to the strip plane and a flow in the longitudinal direction of the strip, is produced on the blown side of the web-shaped material and, if the strip is blown on both sides, on both sides, which flow promotes a particularly uniform and high heat transfer relative to the air volume per nozzle surface. A flow component in the third remaining direction, i.e. transverse to the longitudinal direction of the strip, is substantially avoided by the fact that large portions of the treatment gas can flow off between the longitudinal sides of the nozzle surfaces where no slit-shaped nozzles are provided, unlike the case known from the prior art. In addition, it has further surprisingly been shown that with the nozzle system according to the invention where the volume flow and nozzle pressure is unchanged compared with the prior art, an increased carrying capacity of the treatment gas flow is achieved or the volume flow and/or the nozzle pressure can be reduced for the same weight per unit area of the treated web-shaped material. Thus, the invention also enables the corresponding installation, for example, a levitation strip furnace, to be operated more economically.

The geometry of the slit-shaped nozzles can be configured in different ways. For example, the slit-shaped nozzles can be shaped as rectilinear, where these then preferably run perpendicular to the direction of transport of the material. However, it is also possible for the slit-shaped nozzles to be curved. A further possible configuration consists in the slit-shaped nozzles having a varying width along their longitudinal extension. In this case, it is particularly advantageous if the width of the slit-shaped nozzles increases from the centre of the web-shaped material towards its edges. A centering effect is hereby achieved in the same way as by the curved shape so that in the event that the web-shaped material moves towards the side in an undesirable manner, a restoring force is built up by the gas flow emerging from the broader slit-shaped nozzles at the edge side, which only disappears when the web-shaped material has again adopted a central position. If the width varies along the longitudinal extension of the slit-shaped nozzles, especially if the width of the slit-shaped nozzles increases from the centre of the nozzle surface towards its edges, it is appropriate to configure the respectively adjoining nozzle surface on one side by a slit-shaped nozzle such that its width decreases appropriately.

According to a further advantageous embodiment of the invention, it is provided that channels are formed between the nozzle surfaces which channels widen out perpendicularly to the nozzle surfaces and from the middle of the nozzle surfaces towards their edges. A uniform flow-off of the treatment gas over the entire width of the web-shaped material is hereby achieved, its volume flow increasing towards the edges of the nozzle surfaces.

The invention undergoes a further alternative embodiment wherein the nozzle system allows no flow-off of the treatment gas on one side, for example as a result of cramped installation conditions whereby channels are formed between the nozzle surfaces which channels widen out perpendicularly to the nozzle surfaces on one side from one edge to the other edge. In this case also, a uniform flow-off of the treatment gas to one side is also achieved over the entire width of the web-shaped material.

The invention is explained in detail hereinafter with reference to drawings show an exemplary embodiment. In this figures:

### BRIEF DESCRIPTION OF THE DRAWINGS

FIG. 1 is a perspective view of a nozzle system according to the invention comprising nozzle surfaces bordered in pairs by slit-shaped nozzles,

FIGS. 2 and 3 are perspective views showing two alternative embodiments of the nozzle system from FIG. 1 comprising widening return-flow channels,

FIG. 4a is a perspective view of a pair of nozzle surfaces with slit-shaped nozzles which widen out from the centre towards the edges,

FIG. 4b is a perspective view of a section of a nozzle surface from FIG. 4a with a slit-shaped nozzle which broadens out from the centre towards the edges,

FIG. 5 is a perspective view of a pair of nozzle surfaces with curved slit-shaped nozzles and

FIG. 6 shows the direction of flow of the treatment gas in the nozzle system according to the invention according to FIG. 1.

### DETAILED DESCRIPTION OF THE DRAWINGS

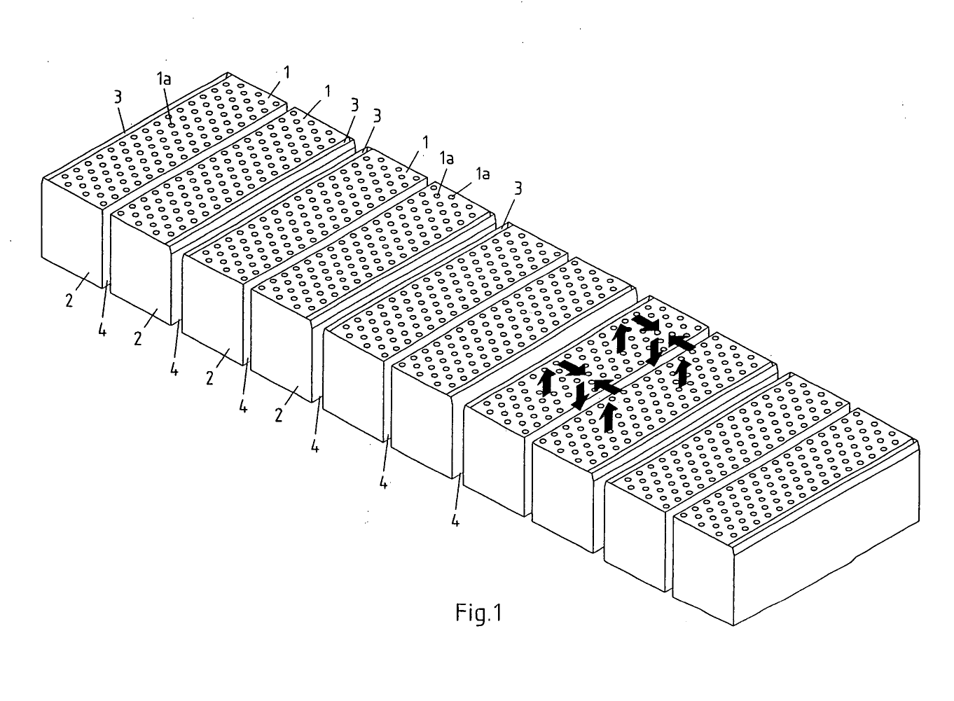

The nozzle system according to FIG. 1 comprises a total of ten successive nozzle surfaces 1 in the direction of transport of a metal strip (not shown). A nozzle system of the same type (not shown) can be arranged above the metal strip. The nozzle surfaces 1 are each arranged on the upper side of nozzle boxes 2 which are connected on the underside to a fan which is not shown. The nozzle surfaces 1 further each have a plurality of nozzle openings 1a, circular-shaped in the present case, through which the treatment gas flowing from the fan into the nozzle boxes 2 flows onto the metal strip. Formed between the nozzle boxes 2 are channels 4 through which the treatment gas flowing onto the surface of the metal strip flows off again. According to the invention, the nozzle surfaces 1 are bordered in groups, in the present case in pairs, by slit-shaped nozzles 3 running transverse to the direction of transport of the material, which are also arranged on the upper side of the nozzle boxes 2. Thus, in the present case, each nozzle surface 1 is allocated a slit-shaped nozzle, wherein each case two slit-shaped nozzles 3 of adjacent pairs of nozzle surfaces are arranged directly adjacent to one another. At these points, the channels 4 are embodied as broader so that in the present case, broader and narrower return flow channels 4 alternate.

The treatment gas flowing out onto the surface of the metal strip over the nozzle surface according to the invention there forms a two-dimensional flow indicated by arrows, resulting in a particularly uniform heat transfer over the entire width of the metal strip.

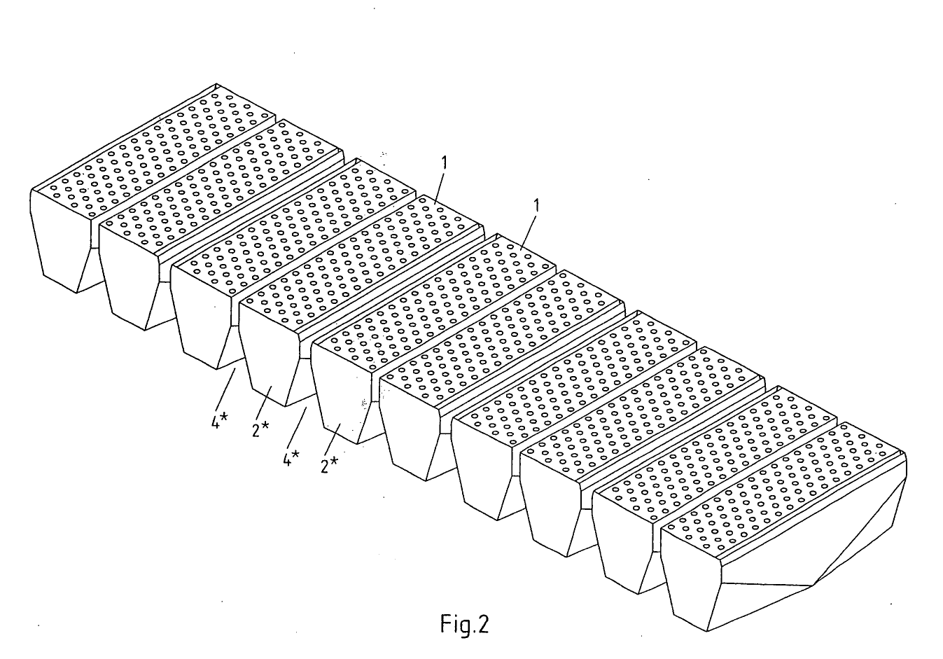

The nozzle system according to FIG. 2 differs from that of FIG. 1 in that the nozzle boxes 2* are formed such that the channels 4* disposed between them widen out perpendicular to the nozzle surface and from the nozzle surface towards its edges. In detail, at their narrow sides the nozzle boxes 2* have a substantially trapezoidal cross-section which goes over continuously into a rectangular cross-section towards the centre of the nozzle boxes 2*. As a result, a uniform flow-off of the treatment gas is achieved over the entire width of the web-shaped material, its volume flow increasing towards the edges of the nozzle surfaces 1.

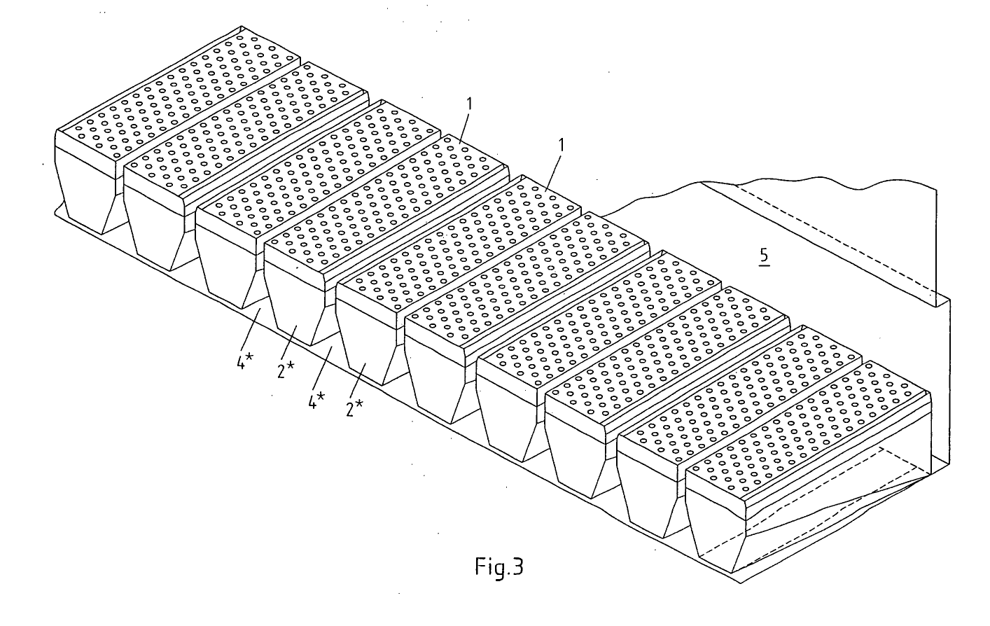

The nozzle system according to FIG. 3 again differs from the nozzle system shown in FIG. 2 in that the nozzle boxes 2* are shaped such that the channels 4* disposed between them also widen out perpendicular to the nozzle surface and from the nozzle surface towards its edges but the nozzle boxes 2* have a substantially trapezoidal cross-section at their narrow sides which, unlike the embodiment shown in FIG. 2, goes over continuously into a rectangular cross section towards the other end of the nozzle box 2*. In the case shown in FIG. 3 for example, where a housing wall 5 is arranged at a short distance from the side surface of the nozzle boxes 2*, it is hereby ensured that the treatment gas can likewise flow off uniformly over the entire width of the web-shaped material towards an edge of the nozzle surfaces 1.

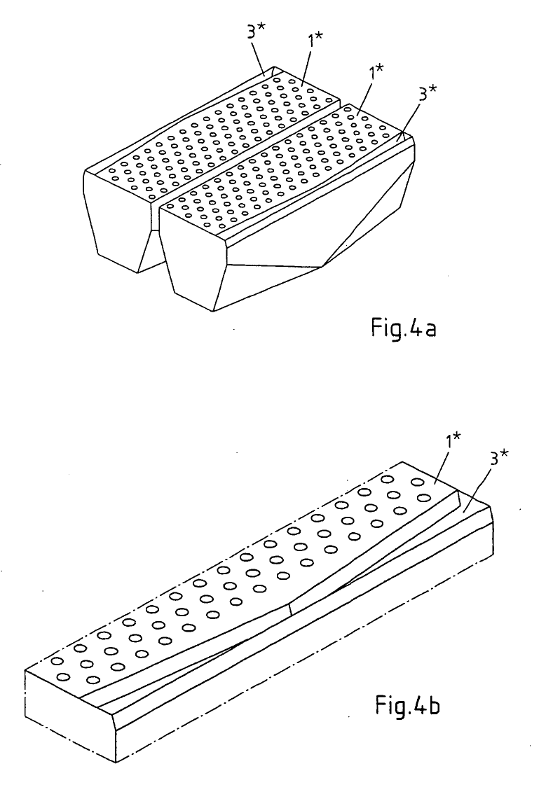

Only one pair of nozzle surfaces is shown in FIGS. 4a and 5.

According to FIG. 4a, the width of the slit-shaped nozzles 3* bordering the two nozzle surfaces 1* increases from the middle of the nozzle surfaces 1* towards its edges. The width of the nozzle surfaces 1* bordered by the slit-shaped nozzles 3* on one side decreases by the same amount so that the nozzle surfaces 1* together acquire the shape of a double trapezium whereas the nozzle surfaces 1* together with the slit-shaped nozzles 3* bordering them form a rectangle.

FIG. 4b shows an enlarged section from FIG. 4a of a nozzle surface 1* with a slit-shaped nozzle 3* which widens out from the centre towards the edges.

FIG. 5 shows a pair of nozzle surfaces 1**, 1** where the slit-shaped nozzles 3** each have a curved shape so that the nozzle surfaces 1** are barrel-shaped.

A centering effect is achieved by the shapes of the nozzle surfaces and the slit-shaped nozzles shown in FIGS. 4a, 4b and 5 so that if the metal strip moves to the side in an undesirable manner, a restoring force is built up by the gas flow emerging from the slit-shaped nozzles which are broader at the edge or curved and this force only disappears when the web-shaped material has adopted a central position again.

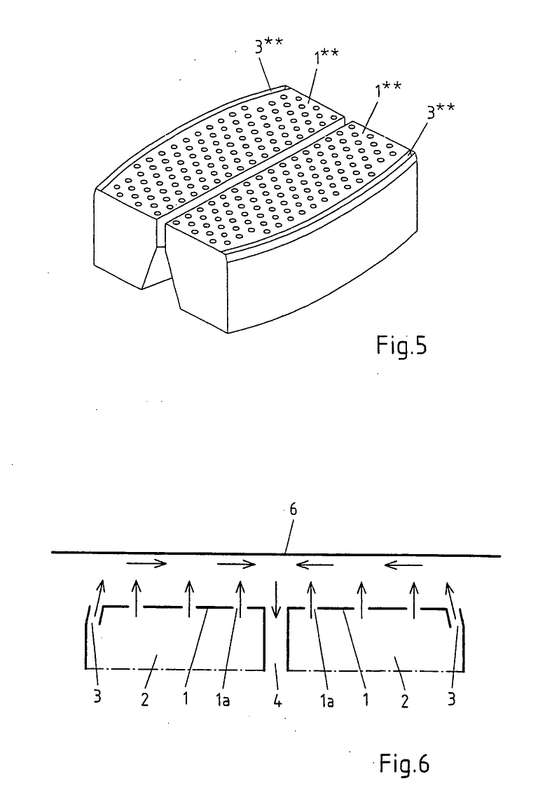

FIG. 6 shows the direction of flow of the treatment gas in the nozzle system according to the invention using arrows. From the nozzle boxes 2 the treatment gas flows via the nozzle openings 1a onto the nozzle surfaces 1 and via the slit-shaped nozzles 3 onto the surface of the metal strip 6 to be treated. A two-dimensional flow is formed on the surface of the metal strip 6 to be treated, where one flow runs perpendicular to the plane of the strip and one flow runs in the longitudinal direction of the strip. A particular uniform and high heat transfer relative to the air volume per nozzle area is thereby achieved. The treatment gas flowing onto the surface of the metal strip from the slit-shaped nozzles 3 and the nozzle apertures 1a flows off again via the channel 4 between the nozzle boxes 2. The flow of the treatment gas into the channel 4 prevents a disadvantageous transverse flow of the treatment gas along the surface of the metal strip 6.

1. A nozzle system for the treatment of web-shaped material, especially metal strip, comprising nozzle surfaces (1, 1*, 1**) each having a plurality of nozzle apertures (1a), disposed at least on one side of the web-shaped material and located successively in the direction of transport of the web-shaped material,
wherein the nozzle surfaces (1, 1*, 1**) are bordered in groups by slit-shaped nozzles (3, 3*, 3**) running transverse to the direction of transport of the material.

2. The nozzle system according to claim 1, wherein the nozzle surfaces (1, 1*, 1**) are bordered in pairs by slit-shaped nozzles (3, 3*, 3**) running transverse to the direction of transport.

3. The nozzle system according to claim 1, wherein the slit-shaped nozzles (3) are shaped rectilinearly.

4. The nozzle system according to claim 3, wherein the slit-shaped nozzles (3) run perpendicular to the direction of transport of the material.

5. The nozzle system according to claim 1, wherein the slit-shaped nozzles (3**) are curve-shaped.

6. The nozzle system according to claim 1, wherein the slit-shaped nozzle (3*) have a width which varies along their longitudinal extension.

7. The nozzle system according to claim 6, wherein the width of the slit-shaped nozzles (3*) increases from the middle of the nozzle surfaces (1*) towards its edges.

8. The nozzle system according to claim 6, wherein the width of the nozzle surfaces (1*) bordered on respectively one side by the slit-shaped nozzles (3*) decreases to the same extent.

9. The nozzle system according to claim 1, wherein channels (4*) are formed between the nozzle surfaces (1, 1*) which channels widen out perpendicularly to the nozzle surfaces and from the middle of the nozzle surfaces towards their edges.

10. The nozzle system according to claim 1, wherein channels (4*) are formed between the nozzle surfaces (1, 1*) which channels widen out perpendicularly to the nozzle surfaces on one side from one edge to the other edge.
